(19) United States
(12) Patent Application Publication
(10) Pub. No.: US 2024/0350361 A1
(43) Pub. Date: Oct. 24, 2024

(54) VENTED CAPS FOR DISPENSERS AND METHODS OF USING THE SAME

(71) Applicant: SILGAN DISPENSING SYSTEMS HEMER GMBH, RICHMOND, VA (US)

(72) Inventor: MAREK CIEZAREK, DORTMUND (DE)

(21) Appl. No.: 18/704,754

(22) PCT Filed: Nov. 15, 2022
(86) PCT No.: PCT/IB2022/060980

§ 371 Date: Apr. 25, 2024

Related U.S. Application Data
(60) Provisional application No. 63/281,163, filed on Nov. 19, 2021.

(51) Int. Cl. A61J 1/14

(52) U.S. Cl. CPC A61J 1/1412

(57) ABSTRACT

A vented cap for a dispenser or dispensing system having a cap and a vent plug, the cap and vent plug engaged in a sealing position in a delivery or non-use state and disengaged in a vented state; the vent plug moveable relative to the cap only after having been engaged by the attached dispenser after a tamper evident or tear strip is removed.

### BACKGROUND OF THE INVENTION

Field of the Invention: Embodiments of the invention relate to cap for dispensers and more particularly to caps with venting features allowing venting of an interior space defined by the cap.

Description of Related Art: Dispensing devices are well known and are used for various purposes. Many dispensing devices, including sprayers, fine mist sprayers, droppers, and other such products, include or utilize a cap to cover the sprayer when not in use, during shipping, or when displayed on a shelf at a retail location. Such caps or covers may be removed by a user and discarded or reattached to the dispenser after using the dispenser for a desired purpose. The configuration and use of such caps is well known and common in the industry.

In some markets it is desirable to have a cap that is capable of venting and interior portion of the cap. Such venting may provide air circulation to dry out or evaporate product remaining on a dispenser surface after use. The venting of an interior cap space and the evaporation of residual product may also help prevent the growth or formation of bacteria, mold, or other undesired agents on the dispenser or an interior cap surface, and in some markets, venting may be required. For example, dispensers used in some healthcare or pharmaceutical applications may be required to have a cap with venting features to ensure that ventilation of the dispenser surface may be accomplished when a cap is placed over the dispenser during non-use or storage. A good example of products using a dispenser that may be required to have—or may benefit from—a venting cap are ophthalmic products. Such products may be of the preservative or preservative-free variety. When used, residual product may be retained on a surface of the dispenser being used to dispense the product. In order to help reduce the formation, growth, or capture of bacteria and other agents on the dispenser surface or in the residual material thereon, a venting cap may be required to allow air to flow over the dispenser head so that residual product may evaporate. This may reduce the formation, growth, or capture of unwanted substances on the dispenser which could be transmitted to a user during subsequent use of the product and dispenser.

While various venting or vented caps exist in the market, there is a need for improvements. In addition, existing venting systems may be difficult to manufacture, assemble, and use with various dispenser systems. Therefore, alternative designs are desired.

### BRIEF SUMMARY OF THE INVENTION

According to certain embodiments of the invention, a vented cap includes a delivery state in which the venting cap is not vented and a vented state in which the venting cap is vented. The vented cap may include a cap portion and a vent plug portion. The vent plug portion may be assembled to the cap and connected to the cap in an interior space of the cap. When assembled and in a delivery state, the vent plug may seal against the cap, preventing venting into an interior of the cap. Movement of the vent plug relative to the cap positions the vent plug such that air or atmosphere may enter an interior space of the cap in a vented state.

According to various embodiments of the invention, a vent plug may be moved relative to the cap when a user removes a tear strip from the cap, exposing a void, which allows the cap to be further moved relative to a dispenser to which the vented cap is attached. A dispenser flange on the vent plug seats against the dispenser to which the vented cap is attached. When the cap is moved relative to the dispenser following removal of the tear strip, the dispensing flange is stopped by the dispenser, stopping movement of the vent plug, but not the cap. The continued movement of the cap dislodges the connection between the cap and the vent plug, opening a space between the vent plug and cap which allows the venting of an interior of the cap.

According to various embodiments of the invention, a vent plug may be assembled into a cap by inserting the vent plug into an opening in the cap. As the vent plug is inserted, portions of the vent plug may pass a vent retainer until a connector on the vent plug engages the vent retainer and secures the vent plug in the cap. In such position, a cap seal on the vent plug and a vent seal on the cap are also engaged, preventing air or atmosphere flow between the vent plug and cap, thereby preventing venting. This is a delivery state.

A vented cap according to various embodiments of the invention may be manufactured and sold as a vented cap. In other embodiments, a vented cap may be assembled or connected to a dispenser and a dispensing product comprising the dispenser and a vented cap may be sold. For example, an ophthalmic dispenser may be assembled with a vented cap and sold to a company filling ophthalmic products. The dispensing product may then be assembled to a container containing a product which may be dispensed by the dispenser in a dispensing mode.

### BRIEF DESCRIPTION OF THE SEVERAL VIEWS OF THE DRAWINGS

While the specification concludes with claims particularly pointing out and distinctly claiming particular embodiments of the present invention, various embodiments of the invention can be more readily understood and appreciated by one of ordinary skill in the art from the following descriptions of various embodiments of the invention when read in conjunction with the accompanying drawings in which:

FIG. 1 illustrates a dispensing system according to various embodiments of the invention;

FIG. 2 illustrated a cap according to various embodiments of the invention;

FIG. 3 illustrates a vent plug according to various embodiments of the invention;

FIG. 4 illustrates a cross-sectional view of a vented cap in a delivery state according to various embodiments of the invention;

FIG. 5 illustrates a cross-sectional view of a vented cap on a dispenser in a delivery state according to various embodiments of the invention;

FIG. 6 illustrates a cross-sectional view of a vented cap on a dispenser in a vented state according to various embodiments of the invention;

FIG. 7 illustrates a dispensing product in a delivery state;

FIG. 8 illustrates a dispensing product in a delivery state without a tear strip; and

FIG. 9 illustrates a dispensing product in a vented state.

### DETAILED DESCRIPTION OF THE INVENTION

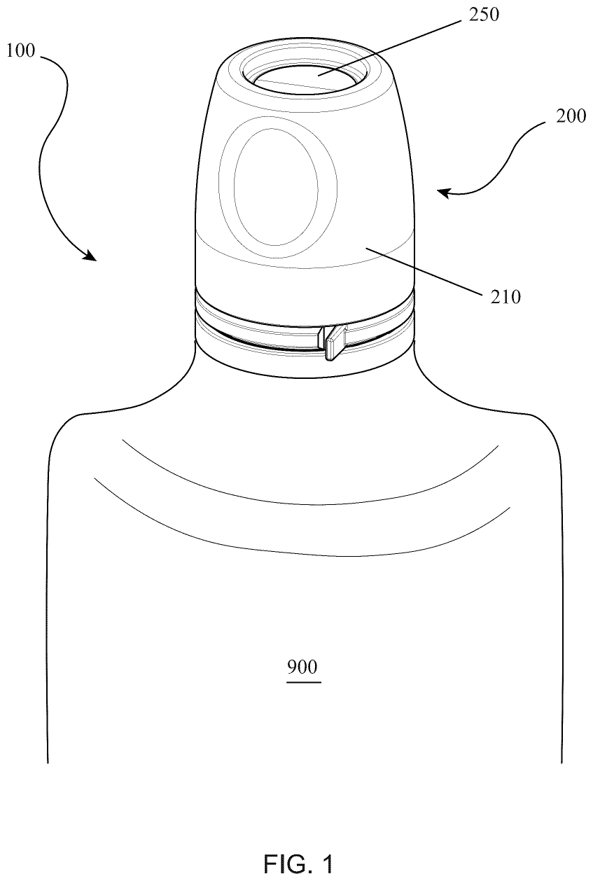

A dispensing system 100 according to various embodiments of the invention is illustrated in FIG. 1. A dispensing system 100 may include a dispenser 110 attached to a container 900, or bottle, and a vented cap 200 over the dispenser 110. The vented cap 200 may include a cap 210 and a vent plug 250 as illustrated. According to various embodiments, a vent plug 250 may be sealed against the cap 210 in a delivery state as illustrated in FIG. 1. In a vented state, the vent plug 250 may be unseated from the cap 210 such that the combination of the vent plug 250 and cap 210 allows air or atmosphere to flow into and out of an interior space of the vented cap 200.

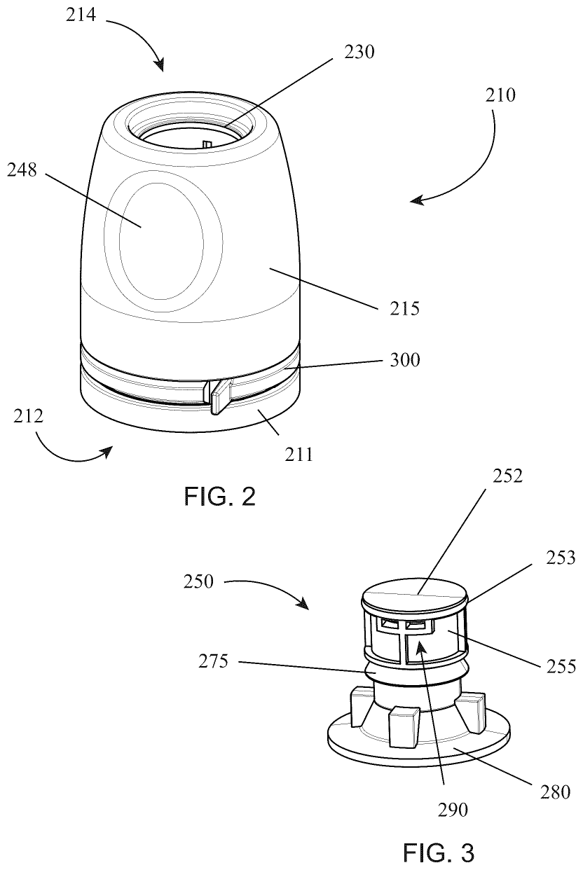

A cap 210 according to various embodiments of the invention is illustrated in FIG. 2. A cap 210 may include a cap wall 215 extending between a bottom opening 212 and a top opening 214. As illustrated in FIG. 2, the cap wall 215 may extend back into an interior of the cap 210 to form features to retain a vent plug 250. A cap 210 may include a vent seal 230 adjacent the top opening 214. A vent seal 230 may be configured to seal with a portion of a vent plug 250. A cap 210 may also include one or more finger pads 248 located on the cap wall 215 to facilitate the gripping of the cap 210 by a user or to provide indicia for a user about how to remove a cap 210 or where to place fingers to remove a cap 210 from a dispenser 110.

According to some embodiments of the invention, a cap 210 in a delivery state may also include a tear strip 300. The tear strip 300 may provide a tamper-evident visual cue to a user such that if the tear strip 300 is not present, a user knows that the cap vented cap 200 may have been used or removed from a dispenser 110 previously. In some embodiments of the invention, a tear strip 300 may be co-molded as a part of a cap 210, having creases or weakened portions or lines which allow the removal of the tear strip 300 from the cap 210 for first use. The use of tear strips 300 such as that illustrated are known and used to provide tamper-evidence and any commonly used tear strip 300 configurations may be utilized with various embodiments of the invention.

While the use of tear strips 300 for tamper-evidence purposes are known, the use of the tear strip 300 with embodiments of the invention provides an additional benefit. When removed, the tear strip 300 creates a gap or space between an upper portion of the cap 210 and a lower ring 211 which may remain attached to a container 900. When a cap 210 is attached to a dispenser 110 after the gap has been revealed, the cap 210 may continue to be pressed onto the dispenser 110 such that the cap 210 moves into the gap. In doing so, the vent plug 250 may be dislodged from its seat in the cap 210, forming a vent in the vented cap 200.

A vent plug 250 according to various embodiments of the invention is illustrated in FIG. 3. While the vent plug 250 has a particular configuration or aesthetic look in FIG. 3, it is understood that vent plugs 250 according to various embodiments of the invention are not limited by the illustrated aesthetics or features. In addition, a vent plug 250 may be configured to facilitate efficient molding of the vent plug 250, efficient assembly of a vent plug 250 with a cap 210, or both.

As illustrated, a vent plug 250 according to various embodiments of the invention may include a vent hood 252 having a cap seal 253 around an edge thereof. The cap seal 253 may be configured to mate with or seal against the vent seal 230 of a cap 210. An outer skirt 255 or wall may extend off and away from an underside of the vent hood 252 as illustrated. The outer skirt 255 may define a hollow interior space within the vent plug 250. The outer skirt 255 may terminate at or with a dispenser flange 280. A dispenser flange 280 may be configured to interact with a surface of a dispenser 110 during a delivery state, a venting state, or both.

One or more vent holes 290 may be located in the outer skirt 255, providing an opening from an exterior of the outer skirt 255 to an interior of the vent plug 250. In other embodiments, a vent hole 290 may include a channel, groove, or series of ridges or grooves in an outer surface of the outer skirt 255 which are exposed to atmosphere when the vent plug 250 is in a venting state such that air or atmosphere may flow into an interior of the cap 210 through the one or more vent holes 290.

According to various embodiments of the invention, the outer skirt 255 of a vent plug 250 may be configured to interact with a vent plug support 220 on an interior of a cap 210. In addition, a vent plug 250 may include a connector 275 configured to mate with a vent retainer 220 in a delivery state and to be moved away from the vent retainer 220 in a venting state. As illustrated in FIG. 3, a connector 275 may include a tooth feature—such as a tooth having a generally triangular cross-section—circumscribing the outer wall 255 of the vent plug 250. The connector 275 may snap fit or otherwise engage a vent retainer 225 in a delivery state.

While the connectors 275 illustrated in various embodiments of the invention are of the tooth-like variety, it is understood that other connector 275 shapes or configurations may be used with embodiments of the invention. For instance, a connector 275 may include one or more snap beads capable of fitting into or snapping into corresponding groove or features on an interior of a cap 210, creating a fixed position of between the vent plug 150 and cap 210. In addition, multiple connectors 275 may be used as desired.

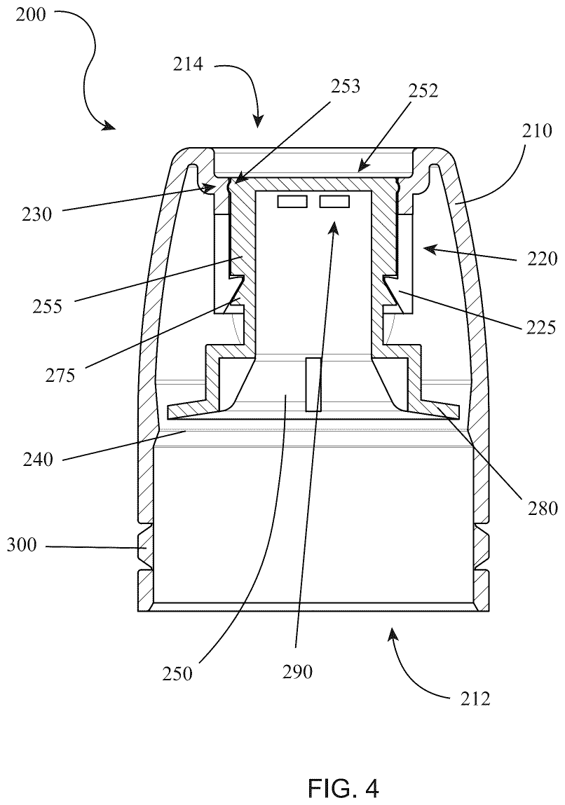

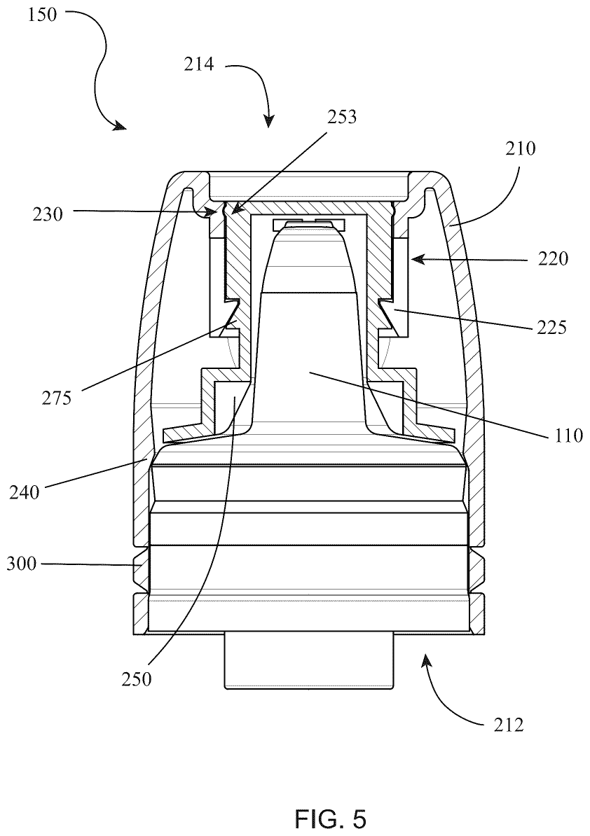

A cross-sectional view of a vented cap 200 in a delivery state—or the state in which the vented cap 200 is produced before being attached to a dispenser 110—is illustrated in FIG. 4. The same cross-sectional view is illustrated in FIG. 5 after having been connected to a dispenser 110. According to various embodiments of the invention, a dispensing product 150 may include a dispenser 110 connected to a vented cap 200 in a delivery state as illustrated in FIG. 5. A dispensing product 150 may be manufactured, assembled, and sold to be attached to a container 900 holding a product. For example, a dispensing product 150 may be sold to a filler who obtains containers 900, fills the containers 900 with a product and attaches a dispensing product 150 according to various embodiments of the invention to the containers 900 filled with product.

As illustrated in FIG. 4, a vented cap 200 includes a cap 210 and a vent plug 250 moveably attached to the cap 210. A vent plug 250 may include one or more connectors 275 which mate with or seat in a vent retainer 225 on a vent plug support 220 of the cap 210. As illustrated, a connector 275 may include a tooth structure mated with an opposing tooth structure defined by the vent retainer 225. In the illustrated embodiment, the vent retainer 225 includes a tooth seated in a tooth-shaped gap which is a portion of the connector 275. In the seated position, the vent plug 250 is seated in the cap 210 such that the cap seal 253 mates with and seals against the vent seal 230 of the cap 210. In this configuration, the vent plug 250 and cap 210 are sealed adjacent the vent hood 252 such that air or atmosphere is not able to pass between the vent plug 250 and cap 210 adjacent the vent hood 252. The vented cap 200 is in a delivery state in which venting will not occur between the cap 210 and the vent plug 250.

In the delivery state, a cap 210 may also include a tear strip 300 as illustrated in FIGS. 4 and 5. The tear strip 300 may include a strip of material bounded by two thinned portions of material such that application of a force on the tear strip 300 may cause the thinned portions of material to separate from the cap 210, releasing the strip of material, or tear strip 300, from the cap 210.

According to certain embodiments of the invention, a vented cap 200 may be assembled by providing a cap 210, providing a vent plug 250, and inserting the vent plug 250 into an interior portion of the cap 210. The vent plug 250 may be inserted into the cap 210 through the bottom opening 212. As the vent plug 250 is inserted into the cap 210, the vent hood 252 or outer skirt 255 or both may apply force to the vent retainer 225 and vent support 220, causing them to flex and allowing a portion of the vent plug 250 to pass by the vent retainer 225. When the vent plug 250 is in a position where the connector 275 mates with the vent retainer 225 and the cap seal 253 is seated in the vent seal 230, insertion of the vent plug 250 is stopped, seating the vent plug 250 in the cap 210.

As illustrated in FIG. 5, a dispensing product 150 may include a vented cap 200 attached to or otherwise locked on a dispenser 110. The positioning and attachment of the vented cap 200 may seal the interior space of the vented cap 200 from the atmosphere such that air is not able to enter the interior space defined by the vented cap 200 and the atmosphere within the dispensing product 150 is fixed and will not change until such time that the vented cap 200 is removed from the dispenser 110.

According to some embodiments of the invention, when a vented cap 200 is assembled on a dispenser 110, the dispenser flange 280 may rest on a portion of the dispenser 110 such as an upper surface thereof as illustrated in FIG. 5. In other embodiments, the dispenser flange 280 need not be touching or resting on the dispenser 110 in a delivery state in which the cap seal 253 is seated and engaged with the vent seal 230.

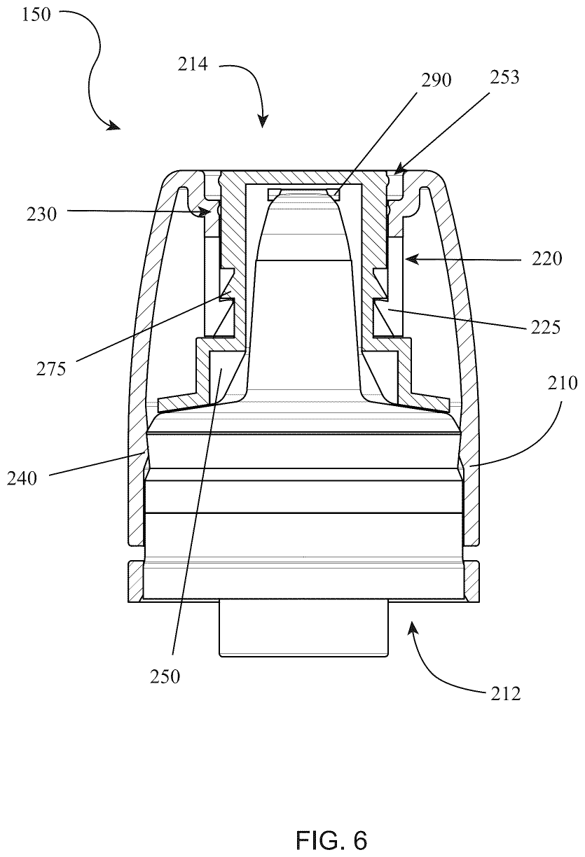

A dispensing product 150 having a vented cap 200 in a vented state is illustrated in FIG. 6. As shown, the tear strip 300 has been removed from the vented cap 200 and the vent plug 250 has moved relative to the cap 210. In this vented position, the cap seal 253 has also disengaged with the vent seal 230. The cap 210 may be pushed down on the dispenser 110 into a position where the dispenser retainer 240 engages with the dispenser 110. For example, the dispenser retainer 240 may include a projection that engages with a groove or channel on the dispenser 110 as illustrated. In this position, the dispenser flange 280 is engaged with an upper surface of the dispenser 110.

When a vented cap 200 is first removed from a dispenser 110 and then reattached, the reattachment fixes the position of the vent plug 250 but allows the cap 210 to continue to move. For example, as the vented cap 200 is reattached to the dispenser 110, the dispenser flange 280 engages a surface of the dispenser 110. The continued movement of the cap 210 and the sloping shape of the connector 275 pushes against the vent retainer 225, allowing the vent retainer 225 and vent plug support 220 to flex, such that the cap 210 continues to move until the vent plug 250 connector 275 is positioned above the vent retainer 225. In this position, one or more vent holes 290 are positioned above a surface of the cap 210, allowing air or atmosphere to flow into an interior space of the cap 210. The air flow into the cap 210 allows residual product remaining on a dispenser 110 after use to evaporate.

According to certain embodiments of the invention, once a vented cap 200 is moved into a vented state, the vent plug 250 is prevented from moving back into the position that it was in during the delivery state. The vent retainer 225 and connector 275 may be shaped such that once the connector 275 has passed by the vent retainer 225 it is unable to move in the opposite direction. For instance, as illustrated in FIGS. 5 and 6, a vent retainer 225 and connector 275 may include tooth-like formations that will allow movement of the vent plug 250 in one direction but not in the opposite direction.

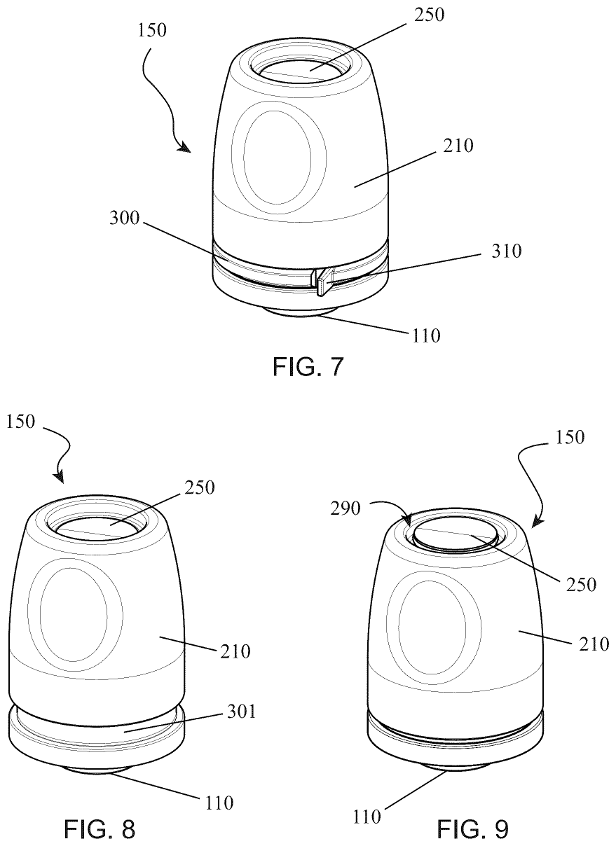

FIGS. 7 through 9 illustrate a dispensing product 150 in delivery and vented states. FIG. 7 illustrates a dispensing product 150 in a delivery state. As illustrated, a vented cap 200 is attached to a dispenser 110. A dispensing product 150 in this state may be sold or delivered to a filling line which the dispensing product 150 may be attached to a container 900 containing a product. To use the dispenser 110 covered by the cap 210, the tear strip 300 must first be removed. In some embodiments of the invention, a tear strip 300 may include a tear tab 310 which a user may grab and use to pull the tear strip 300 off of the vented cap 200.

The dispensing product 150 illustrated in FIG. 8 is shown in the delivery state with the tear strip 300 having just been removed from the vented cap 200. Removal of the tear strip 300 allows a user to remove the vented cap 200 from the dispenser 110. Removal of the tear strip 300 also creates a void 301 where the tear strip 300 once was positioned. The void may allow the cap 210 to be pushed further onto the dispenser 110.

FIG. 9 illustrates a dispensing product 150 in a vented state. With the tear strip 300 removed, a user may push the cap 210 further down the dispenser 110 into the void left by the removal of the tear strip 300. Movement of the cap 210 into the void allows the vent plug 250 to engage with the dispenser 110. For example, a dispenser flange 280 may engage a surface of the dispenser 110, moving the vent plug 250 relative to the cap 210. In the vented state, the vent plug 250 position relative to the cap 210 opens one or more vent holes 290, allowing air or atmosphere to flow between the cap 210 and the vent plug 250 and into an interior space of the cap 210. The flow of air or atmosphere into and through the cap 210 interior may dry off the dispenser 110 or facilitate the evaporation of residual product on the dispenser 110 after use.

According to some embodiments of the invention, vent plug 250 may extend above a venting surface of the cap 210 but not outside the top opening 214 in the cap 210 as illustrated in FIG. 6. The positioning of vent plug 250 below or flush with the edge of the top opening 214 of the cap 210 in a venting state is advantageous because it presents a smooth or level upper surface made up of a surface of the vent plug 250 and the edge of the cap 210. In this manner, unwanted forces applied to the vent plug 250 may be avoided and the vent plug 250 is less likely to catch in use. In other embodiments it may be desirable or advantageous for the vent plug 250 to extend above the upper edge of the top opening 214 of the cap 210.

Caps 210 and vent plugs 250 according to various embodiments of the invention may be molded from plastic or resin materials. Materials commonly used to mold parts for dispensers, sprayers, pumps, caps, and other such consumer products may be used with various embodiments of the invention. The cap 210 and vent plug 250 may be molded with the same material or with different materials. In addition, colorants may be used during molding. In some embodiments, the cap 210 and vent plug 250 may be molded in the same color and in other embodiments, they may be molded in different colors.

A cap 210, a vent plug 250, or both may also be molded with additives included in or included within their structures. For example, anti-microbial additives commonly used with dispensing systems, caps and other components of dispensers, droppers, and pumps used for healthcare or pharmaceutical formulations may be molded into the cap 210, vent plug 250 or both. In addition, a cap 210, vent plug 250, or both may be coated with an anti-microbial material as desired.

A vented cap 200 according to various embodiments of the invention may be used with any type of dispenser, sprayer, dropper, or other delivery device as needed. In at least some embodiments, the vented cap 200 may be used with dispensers used to spray or otherwise deliver pharmaceutically active products. Dispensers used with a vented cap 200 may include nasal spray dispensers, ophthalmic dispensers, medicine droppers, or other types of dispensers. For example, a vented cap 200 according to embodiments of the invention may be used as a capo 21_9018_Swith an ophthalmic dispenser such as those disclosed in U.S. Pat. No. 10,829,276, which is incorporated by reference herein in its entirety. While certain dispensers are described herein, such are not limiting to the various embodiments of the invention.

Having thus described certain particular embodiments of the invention, it is understood that the invention defined by the appended claims is not to be limited by particular details set forth in the above description, as many apparent variations thereof are contemplated. Rather, the invention is limited only be the appended claims, which include within their scope all equivalent devices or methods which operate according to the principles of the invention as described.

What is claimed is:

1. A dispensing product, comprising:
a dispenser; and
a vented cap attached to the dispenser, the vented cap comprising:
a cap; and
a vent plug, wherein the vent plug is moveable from a delivery state to a vented state.

2. The dispensing product of claim 1, wherein the dispenser comprises an ophthalmic dispenser.

3. The dispensing product of claim 1, further comprising a tear strip in the cap.

4. The dispensing product of claim 1, wherein the cap further comprises:
a bottom opening;
a top opening;
a cap wall extending between the bottom opening and the top opening;
a cap interior space defined by the cap wall;
a vent retainer positioned in the cap interior space; and
a vent seal adjacent the top opening.

5. The dispensing product of claim 4, further comprising:
a vent plug support extending off the cap wall from the top opening into the cap interior space, wherein the vent plug support terminates in the vent retainer;
a dispenser retainer encircling a portion of the cap interior space adjacent the bottom opening; and
a finger pad on an exterior surface of the cap wall.

6. The dispensing product of claim 1, wherein the vent plug further comprises:
a vent hood;
a cap seal encircling the vent hood;
an outer skirt extending off a lower surface of the vent hood;
at least one vent hole in the outer skirt;
a connector extending off a portion of the outer skirt; and
a dispenser flange extending off a bottom of the outer skirt.

7. The dispensing product of claim 1, further comprising:
a bottom opening in the cap;
a top opening in the cap;
a cap wall extending between the bottom opening and the top opening;
a cap interior space defined by the cap wall;
a vent retainer positioned in the cap interior space;
a vent seal adjacent the top opening;
a vent hood in the vent plug;
a cap seal encircling the vent hood;
an outer skirt extending off a lower surface of the vent hood;
at least one vent hole in the outer skirt;
a connector extending off a portion of the outer skirt; and
a dispenser flange extending off a bottom of the outer skirt.

8. The dispensing product of claim 7, wherein the connector is attached to the vent retainer and the cap seal is seated against the vent seal.

9. The dispensing product of claim 7, wherein the connector is seated between the vent retainer and the top opening in the cap and the cap seal is not seated against the vent seal.

10. The dispensing product of claim 7, further comprising:
a delivery state in which the cap seal is seated against the vent seal; and
a vented state in which the cap seal is not seated against the vent seal.

11. A vented cap, comprising:
a cap; and
a vent plug moveably attached to the cap.

12. The vented cap of claim 11, wherein the cap further comprises:
a bottom opening;
a top opening;
a cap wall extending between the bottom opening and the top opening;
a cap interior space defined by the cap wall;
a vent retainer positioned in the cap interior space; and
a vent seal adjacent the top opening.

13. The vented cap of claim 11, wherein the vent plug further comprises:
a vent hood;
a cap seal encircling the vent hood;
an outer skirt extending off a lower surface of the vent hood;
at least one vent hole in the outer skirt;
a connector extending off a portion of the outer skirt; and
a dispenser flange extending off a bottom of the outer skirt.

14. The vented cap of claim 11, further comprising:
a bottom opening in the cap;
a top opening in the cap;
a cap wall extending between the bottom opening and the top opening;
a cap interior space defined by the cap wall;
a vent retainer positioned in the cap interior space;
a vent seal adjacent the top opening;
a vent hood in the vent plug;
a cap seal encircling the vent hood;
an outer skirt extending off a lower surface of the vent hood;
at least one vent hole in the outer skirt;
a connector extending off a portion of the outer skirt; and
a dispenser flange extending off a bottom of the outer skirt.

15. The vented cap of claim 14, further comprising:
a delivery state in which the cap seal is seated against the vent seal; and
a vented state in which the cap seal is not seated against the vent seal.

16. A method for assembling a dispensing product, comprising:
providing a cap;
providing a vent plug; and
inserting the vent plug into said cap until the vent plug seals with said cap, forming a vented cap.

17. The method of claim 16, wherein said cap comprises:
a bottom opening;
a top opening;
a cap wall extending between the bottom opening and the top opening;
a cap interior space defined by the cap wall;
a vent retainer positioned in the cap interior space; and
a vent seal adjacent the top opening.

18. The method of claim 16, wherein said vent plug comprises:
a vent hood;
a cap seal encircling the vent hood;
an outer skirt extending off a lower surface of the vent hood;
at least one vent hole in the outer skirt;
a connector extending off a portion of the outer skirt; and
a dispenser flange extending off a bottom of the outer skirt.

19. The method of claim 16, further comprising:
providing a dispenser; and
assembling the vented cap on the dispenser.

20. The method of claim 16, further comprising:
providing a dispenser;
assembling the vented cap on the dispenser; and
attaching the assembled vented cap and dispenser to a container.
